(19) United States
(12) Patent Application Publication
(10) Pub. No.: US 2015/0106113 A1
(43) Pub. Date: Apr. 16, 2015

(54) Near Field Communication (NFC) Based Counterfeit Product Identification System

(71) Applicant: Tresbu Technologies Pvt. Ltd., Bangalore, Karnataka (IN)

(72) Inventor: Maheshwar Sriyapu Reddy, Bangalore (IN)

(73) Assignee: Tresbu Technologies Pvt. Ltd., Bangalore, Karnataka (IN)

(21) Appl. No.: 14/378,341

(22) PCT Filed: Feb. 13, 2013
(86) PCT No.: PCT/IB13/51165

§ 371 Date: Aug. 13, 2014

(30) Foreign Application Priority Data
Feb. 13, 2012 (IN) 525/CHE/2012

(51) Int. Cl. G06Q 30/00; G06Q 50/22

(52) U.S. Cl. CPC G06Q 30/0185; G06Q 50/22
USPC 705/2

(57) ABSTRACT

A counterfeit pharmaceutical product identification system and method for determining authenticity of pharmaceutical products using NFC (Near Field Communication) enabled mobile device is disclosed. A unique secure code, invisible to human eyes, is embedded inside the packaging of the pharmaceutical products. An authentication server stores a database of pharmaceutical products and the unique secure codes associated with each of the pharmaceutical products. At least one mobile device, connected to the server, is configured to read unique secure code embedded inside the packaging of the pharmaceutical product, by bringing the mobile device in close proximity to the packaging. The mobile device authenticates the pharmaceutical product by communicating with the authentication server and comparing the unique secure code attached to the pharmaceutical product with the secure code saved in the database whereby identifying the genuine pharmaceutical product instantly.

### FIELD OF THE INVENTION

The present invention relates to a system and method of verifying the authenticity of the pharmaceutical products using mobile devices. In particular the present invention relates to the use of NFC tag technology to identify the genuine pharmaceutical products from counterfeit ones.

### BACKGROUND OF THE INVENTION

Counterfeit products are fake replicas of the real product and are often produced with the intent to take advantage of the superior value of the imitated product. The industry which is most affected with the counterfeit problem is pharmaceutical drugs and other pharmaceutical products which is spreading widely worldwide. A counterfeit drug may contain inappropriate quantities of active ingredients, or none, may be improperly processed within the body (e.g., absorption by the body). At times it may contain ingredients that are not on the label (which may or may not be harmful), or may be supplied with inaccurate or fake packaging and labelling.

Counterfeit medicines pose a public health risk because their content can be dangerous or they may lack active ingredients. Their use may result in treatment failure and contribute to increased resistance (e.g. in the case of antimalarials that contain insufficient active ingredient) or even death.

The growth in international trade of pharmaceutical ingredients and medicines adds a further dimension of complexity to this issue. For example, trade through brokers and free trade zones where regulation is lax or absent (and medicines are repackaged and relabeled to conceal the country of origin) is increasing. Counterfeiting medicines is a very lucrative business since many countries have not yet enacted deterrent legislation, counterfeiters often do not fear prosecution.

Counterfeiting is greatest in regions where regulatory and enforcement systems for medicines are weakest. The World Health Organization estimates that around 10 percent of all drugs around the world are counterfeit. In most industrialized countries with effective regulatory systems and market control (i.e. Australia, Canada, Japan, New Zealand, the United States of America, and most of the European Union), incidence of counterfeit medicines is extremely low—less than 1% of market value according to the estimates of the countries concerned. But in less developed countries, the percentage of counterfeit drugs in circulation could be as high as 33 percent. The United States Customs seized $16.8 Million worth of counterfeit drugs in FY 2011, an increase of roughly $11 Million from FY 2010. 1,239 seizures by the US Customs involved counterfeit drugs, representing 9 percent of the total counterfeit goods seized during the year. Between 2005 and 2010, the Government of Indonesia lost $4.76 Billion (43.2 Trillion Indonesian Rupiah) in tax revenue due to counterfeit drugs. Scientists reported finding counterfeit and substandard malaria drugs on sale in 11 African countries between 2002 and 2010. Some of the counterfeit drugs were discovered to have incorrect mixtures of chemicals, while other had ingredients that were not supposed to be in the medicine and could cause serious harm if taken with other medication. During July 2009 and July 2011, police in China investigated over 42,000 cases of counterfeit drugs and shut down 1,093 illegal websites that were selling fake drugs.

Drug manufacturers and distributors are increasingly investing in countermeasures, such as traceability and authentication technologies, to try to minimise the impact of counterfeit drugs. In spite of increasing evolution of technology, many developed, developing and underdeveloped nations, are unable to cope with the problem of counterfeiting medicines. There is no technology available which may be used easily, and is cheap to incorporate.

Hence, there is a need of a simple and reliable system that allows the consumer to validate the authenticity of the pharmaceutical products using readily available devices.

### SUMMARY OF THE INVENTION

The present invention overcomes problems in the prior art and provides a counterfeit pharmaceutical product identification system for determining authenticity of pharmaceutical products. In one embodiment, the system mainly comprises at least one pharmaceutical product having at least one tag containing an encrypted unique secure code wherein the tag is embedded inside the packaging of the pharmaceutical product making the unique secure code invisible to human eyes. The system includes an authentication server storing a database of pharmaceutical products and the unique secure codes associated with each of the pharmaceutical products. The system further includes at least one mobile device configured to read unique secure code embedded inside the packaging of the pharmaceutical product, by bringing the mobile device in close proximity to the packaging wherein a short range communication system is used to establish connection between the mobile device and the pharmaceutical product. The mobile device authenticates the pharmaceutical product by communicating with the authentication server by comparing the unique secure code attached to the pharmaceutical product with the secure code saved in the database. In case the pharmaceutical product is identified by the mobile device as authentic, a success message, along with product details including date of manufacture and date of expiry, is displayed on the display screen of the mobile device whereby identifying the genuine pharmaceutical product instantly. In case the pharmaceutical product is not identified by the mobile device, a failure message is displayed on the display screen of the mobile device whereby identifying the counterfeit pharmaceutical product instantly. The unique secure code further comprises at least one of the manufacturer identification code, product identification code, manufacturing date, manufacturing month, manufacturing year, expiry date, expiry month or expiry year of the pharmaceutical product. The results of authentication may be transmitted in the form of an SMS (Short Messaging Service) or instant messaging by the mobile device. The system uses short range communication technology such as Near Field Communication (NFC) or Bluetooth® technology.

In another embodiment, a counterfeit pharmaceutical product identification system for determining authenticity of pharmaceutical products using digital signatures is provided. In this embodiment, the system mainly comprises at least one pharmaceutical product having at least one tag containing an encrypted unique secure code wherein the secure code is having digital signature information of the manufacturer of pharmaceutical product wherein the tag is embedded inside the packaging of the pharmaceutical product making the unique secure code invisible to human eyes. The system includes at least one mobile device configured to read unique secure code embedded inside the packaging of the pharmaceutical product by bringing the mobile device in close proximity to the packaging wherein a short range communication system is used to establish connection between the mobile device and the pharmaceutical product. The mobile device authenticates the pharmaceutical product by comparing the unique secure code attached to the pharmaceutical product with the digital signatures information stored in the mobile device. The unique secure code further comprises at least one of manufacturer identification code, product identification code, manufacturing date, manufacturing month, manufacturing year, expiry date, expiry month or expiry year of the pharmaceutical product. In case the pharmaceutical product is identified by the mobile device as authentic, a success message, along with product details including date of manufacture and date of expiry, is displayed on the display screen of the mobile device whereby identifying the genuine pharmaceutical products instantly. In case the pharmaceutical product is not identified by the mobile device, a failure message is displayed on the display screen of the mobile device whereby identifying the counterfeit pharmaceutical product instantly. In this embodiment, the short range communication mode is any one of Near Field Communication (NFC) or Bluetooth® technology.

In one more embodiment, a method for determining authenticity of pharmaceutical products is disclosed. The method mainly comprises the steps of embedding the packaging of the pharmaceutical products with tags containing an encrypted unique secure code associated with corresponding pharmaceutical product, storing the list of pharmaceutical products and their unique secure code in an authentication server, activating an authentication application on the mobile device of the user, bringing mobile device in close proximity to the packaging containing pharmaceutical product, authenticating the pharmaceutical product by reading the embedded unique secure code inside the packaging and verifying with the unique secure code stored in the authentication server and transmitting the result to the user. The method of embedding the packaging of the pharmaceutical products with tags containing an encrypted unique secure code further comprises the steps of generating a unique identification number for each of the pharmaceutical products, storing the list of pharmaceutical products with corresponding unique secure code in a authentication server, encrypting the unique secure code and embedding inside the packaging, the tags with unique secure code. The unique secure code further comprises at least one of manufacturer identification code, product identification code, manufacturing date, manufacturing month, manufacturing year, expiry date, expiry month, expiry year of the pharmaceutical product or digital signature information of the pharmaceutical product manufacturer. In case the pharmaceutical product is identified by the mobile device as authentic, a success message, along with product details including date of manufacture and date of expiry, is communicated to the user whereby identifying the genuine pharmaceutical product instantly. In case the pharmaceutical product is not identified by the mobile device, a failure message is communicated to the user whereby identifying the counterfeit pharmaceutical product instantly. The result is transmitted in the form of an SMS (Short Messaging Service) or instant messaging by the mobile device for verification.

Thus, using the present invention, the end user can identify the genuine products against the counterfeited ones. The complete encrypted code is written as NDEF data using NFC technology into the packaging of the pharmaceutical products. Since the unique secure code is embedded inside the product packaging using NFC tag, the unique secure code is generally invisible to the human eyes.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates the counterfeit pharmaceutical product identification system according to one embodiment of the invention.

FIG. 2 illustrates the method of determining authenticity of pharmaceutical products according to one embodiment of the invention.

FIG. 3 illustrates the method of generating the secure code according to one embodiment of the invention.

FIG. 4 illustrates the software generated binary code memory storage format according to one embodiment of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention provides a system and method to authenticate a pharmaceutical products through NFC enabled mobile device using a unique secure code, which is invisible to human eyes, is embedded inside the packaging during manufacturing of pharmaceutical products. Present invention also allows the end user, consumer or distributor to identify the fake pharmaceutical products and report same to the concerned authorities.

The design concept of the present invention is based on Near Field Communication (NFC) tag technology which is a short-range, low power wireless technology evolved from radio-frequency identification (RFID) technology that can transfer small amounts of data between two devices held a few centimeters from each other. Unlike Bluetooth, no pairing code is needed and since its very low power technology, no battery is needed in the device which is being read. NFC forum is an organization responsible for defining standard specifications for NFC technology and defines two types of NFC entities namely NFC Device and NFC tag. NFC device is a device equipped with NFC hardware having capability to discover and communicate with another NFC entity within the range. NFC Tag is a passive device having capability to store related data in a NFC Data Exchange Format (NDEF) which can be read by an NFC device.

Although the present invention will be described with reference to its application to pharmaceutical products but it will be appreciated by person skilled in the art that the invention has applications for other products as well that are vulnerable to counterfeiting and need authentication.

The embodiments of the present invention may be implemented on hardware or a combination of hardware and software. The software/hardware implementations of some embodiments of the present invention may be implemented on a programmable machine selectively activated or reconfigured by a computer program stored in memory. At least some of the features or functionalities of the invention may implemented using on one or more general purpose mobile computing devices such as personal digital assistant, mobile phone, smart phone, laptop, tablet computer etc. Such mobile devices may be adapted to communicate with other computing device such as client and/or server over a communication network such as internet using well known protocols wired or wireless. The computing device includes processor which runs software for implementing multimodal virtual personality. Input device can be of any type suitable for receiving use input, including for example a keyboard, touch screen, touchpad, and/or any combination thereof. Output device may be a screen, speaker and/or any combination thereof. Storage device for storage of data in digital form may be any of: a flash memory, magnetic hard drive, CD ROM or may be storage in cloud environment.

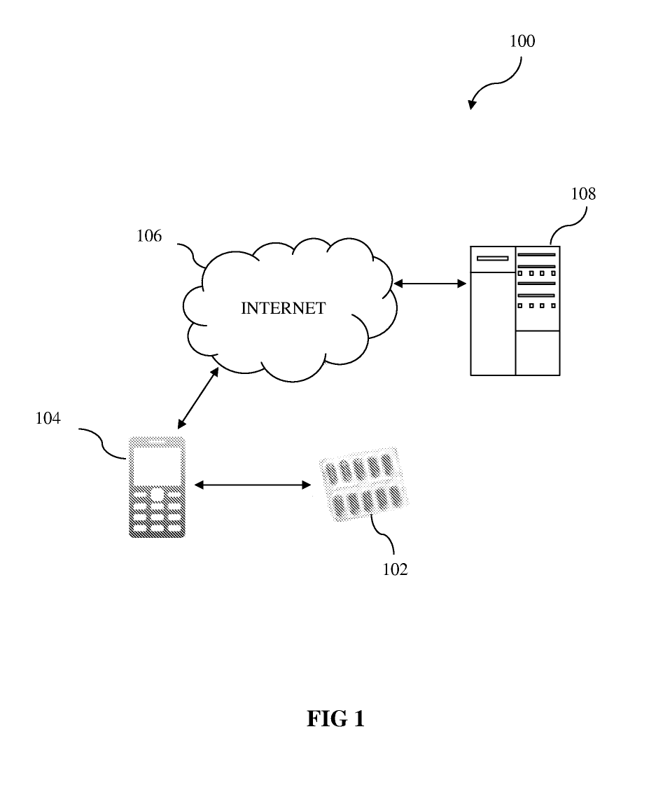

FIG. 1 illustrates the counterfeit pharmaceutical product identification system according to one embodiment of the invention. The counterfeit pharmaceutical product identification system mainly comprises pharmaceutical products (102) having at least one NFC tag containing an encrypted unique code wherein the tag is embedded inside the packaging of the pharmaceutical product (102) making the unique secure code invisible to human eyes. In one embodiment of the invention, the pharmaceutical product manufacturer embeds a unique secure code into each of the NFC tags and embeds inside the product packages at the time of packaging. The embedded unique secure code is known only to the manufacturer and is encrypted. The system includes an authentication server (108) storing a database of pharmaceutical products (102) along with corresponding unique secure codes associated with each of the pharmaceutical products (102). In one embodiment, the authentication server (108) may be accessed via internet (106). The unique secure code is readable only by the NFC reader and is generally not visible to the user via naked eyes and is also tamper proof. When the end user asks for a particular pharmaceutical product (102) such as the medicine from the chemist, the chemist hands over the medicine with embedded unique secure code to the end user. The end user is provided with an NFC enabled mobile device (104) having a vendor specific software application installed inside it. In order to check the genuineness of the medicine, the end user launches the vendor specific software application on the NFC enabled mobile device (104) equipped with NFC reader. When the end user brings the medicine with embedded unique secure code and NFC enabled mobile device (104) within close proximity of approximately 0 to 4 centimeters with each other, the software application inside the NFC enabled mobile device (104) reads the unique secure code from the medicine package by connecting to the authentication server (108) via internet (106). The authentication server (108) compares the data sent by the NFC enabled mobile device (104) against the data saved earlier by the manufacturer while assigning unique secure code for each of the pharmaceutical products. The data pulled out by NFC enabled mobile device (104) is relayed through authentication server (108) for authentication and the output result is sent back to NFC enabled mobile device (104). In case the medicine is identified by the mobile device (104) as authentic, a ‘Success’ message is displayed on the display screen of the mobile device (104) along with medicine details such as date of manufacture and date of expiry whereby identifying the genuine pharmaceutical product instantly else a ‘Failure’ message is displayed on the display screen of the mobile device (104) whereby identifying the counterfeit pharmaceutical product instantly. In other embodiments, the other short range communication modes such as Bluetooth® may also be used in place of NFC technology.

In another embodiment of the invention, the invention provides multiple mechanisms and eco-systems for the verification of the unique secure code embedded in the pharmaceutical product (102). An NFC enabled mobile device (104) along with the associated software application is needed on the end user or consumer side mobile device (104) for the verification of the genuineness of the pharmaceutical product (102). Following embodiments of the invention provide other verification methods for the genuineness of pharmaceutical products (102).

Using Short Messaging Service (SMS)

In this embodiment, the NFC enabled mobile device (104) reads the unique secure code from the NFC tag embedded inside the pharmaceutical product (102) package when the product (102) is brought in the close proximity of 0 to 4 centimeter to the mobile device (104). The NFC reader inside NFC enabled mobile device (104) reads the unique secure code from the packaging and transmits the unique secure code to a pre-defined messaging server using SMS service. The messaging server (not shown in the figure) decodes the unique secure code and compares the unique secure code with the code stored by the manufacturer inside the authentication server (108). In case both the unique secure codes match with each other, the result may be transmitted via SMS with a suitable message such as “Success” to the mobile device (104) of the end user. In case the unique secure codes don't match with each other, the result may be transmitted as an SMS with a suitable message such as “failure” to the mobile device (104) of the end user.

Using a Cloud Based Service

This embodiment of the invention provides a cloud computing based system for managing the database for each product manufactured by pharmaceutical products manufacturer. The manufactures may be provided with a software application having a user interface, using which a user may connect to the said cloud computing environment and update the details of the pharmaceutical products they manufacture. Each manufacturer may have their private database in said cloud computing environment which is completely secure from any other manufacturer in terms of confidentiality or data theft. The NFC enabled mobile device (104) reads the unique secure code from the product (102) package having NFC tag when the pharmaceutical product (102) is brought in the close proximity of 0 to 4 centimeter to the mobile device (104). The software application transmits the unique secure code to the authentication server (108) via internet (106). The authentication server (108) decodes the unique secure code and compares the unique secure code with the one stored by the manufacturer inside the authentication server (108) during packaging. In case both the unique secure codes match with each other, the result may be transmitted via SMS with a suitable message such as “Success” to the mobile device (104) of the end user. In case the unique identification codes don't match with each other, the result may be transmitted as an SMS with a suitable message such as “failure” to the mobile device (104) of the end user.

Verification Using Digital Signature of the Manufacturer

This embodiment of the invention provides a mechanism that can be used and deployed in the regions where mobile network connectivity is not very good. In this embodiment, the details of the manufacturer's digital signature are also included while creating unique secure code. The NFC based system reads the unique secure code from the NFC enabled pharmaceutical product (102) package when the product (102) is brought in the close proximity of 0 to 4 centimeter to the NFC enabled mobile device (104). In the method of verification using digital signature of the manufacturer is verified locally using the digital certificate of the manufacturer stored in the NFC enable mobile device (104). Further comparison is made between the digital signatures of the product (102) with the digital certificate of the manufacturer stored in the NFC enabled mobile device (104). In case the product (102) digital signature and the digital signature of the manufacturer stored in the NFC enabled mobile device (104) are same, the information comprising manufacture name, name of the product, date of manufacture and date of expiry may be displayed on mobile device (104) of the end users. Hence, this system and method of authentication doesn't require connectivity of the NFC reader with the internet (106) and may prove to be quite useful in remote regions with poor network connectivity.

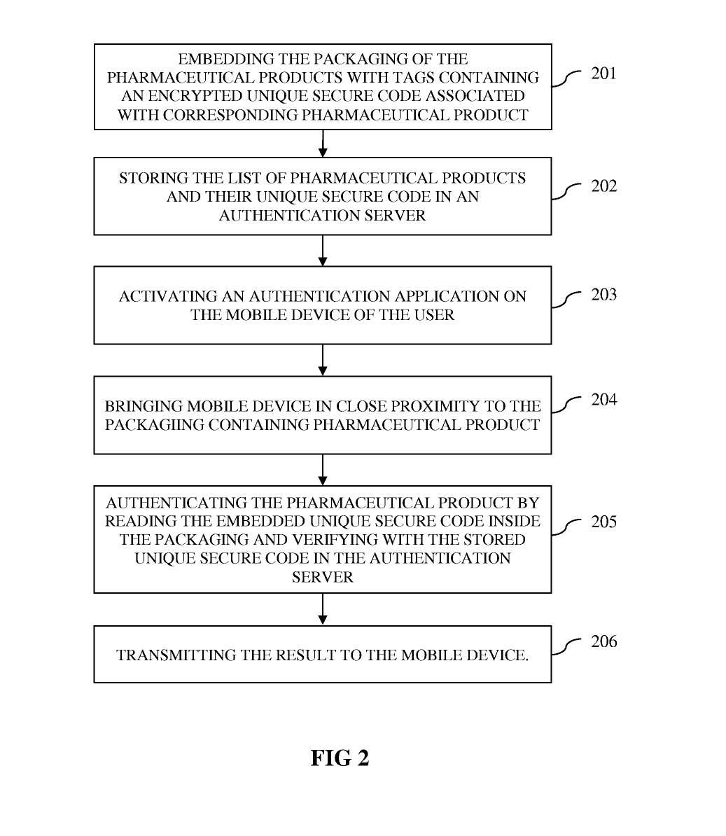

FIG. 2 illustrates the method of determining authenticity of pharmaceutical products according to one embodiment of the invention. At step 201, the packaging of the pharmaceutical products is embedded with NFC tags containing an encrypted unique secure code associated with corresponding pharmaceutical product. At step 202, the list of pharmaceutical products and their unique secure codes is stored in an authentication server. At step 203, the vendor specific software application is activated by the user on his/her NFC enabled mobile device. At step 204, the mobile device is brought in close proximity to the packaging containing pharmaceutical product. At step 205, the pharmaceutical product is authenticated by reading the embedded unique secure code inside the packaging and verifying with the unique secure code stored in the authentication server. At step 206, the result is transmitted to the mobile device. In case the pharmaceutical product is identified by the mobile device as authentic, a ‘Success’ message is displayed on the display screen of the mobile device whereby identifying the genuine pharmaceutical product instantly else a ‘Failure’ message is displayed on the display screen of the mobile device whereby identifying the counterfeit pharmaceutical product instantly. In other embodiments, the other short range communication modes such as Bluetooth® may also be used in place of NFC technology.

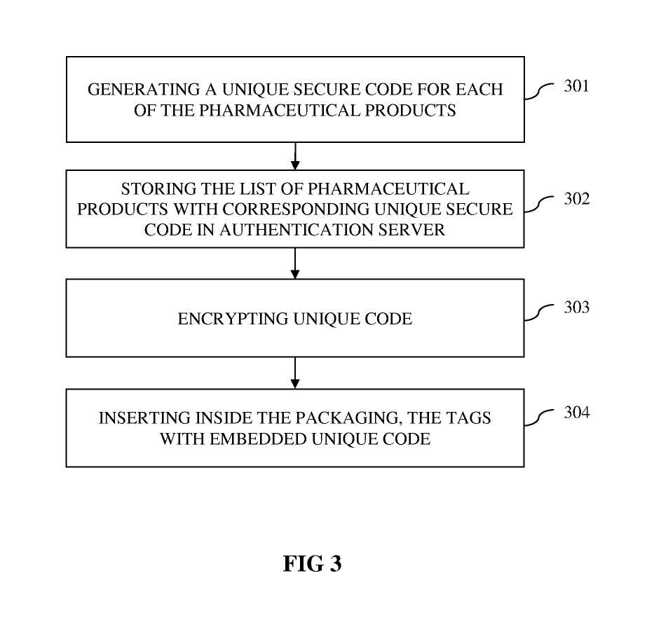

FIG. 3 illustrates the method of generating the secure code according to one embodiment of the invention. The pharmaceutical product manufacturer is provided with a pre assigned unique identification number and a pair of private/public key by a trusted Certificate Authority (e.g. VeriSign) using standard Public Key Infrastructure (PKI mechanism). The pharmaceutical products manufacturer may be provided with a software application having GUI (graphical user interface) that accepts various parameters such as manufacturer identification code, product identification code, manufacturing date/month/year, expiry date/month/year of the pharmaceutical products etc. Based on the above factors, a unique identification code is generated for each product package produced by the manufacturer at step 301. At step 302, the list of products and their corresponding unique identification code is transmitted to the authentication server. Further at step 303 the unique identification code is encrypted using public/private key infrastructure (PKI mechanism) through which encrypted unique secure code is formed. Further, with the encrypted code NDEF (NFC Data Exchange Format) data is produced and this NDEF data is embedded into the product package at step 303. The pharmaceutical product with secure code containing NDEF data are called as NFC enabled pharmaceutical product packages.

Thus, using NFC tag technology, the end user can identify the genuine products against the counterfeited ones. The complete encrypted code is written as NDEF data using NFC technology into the packaging of the pharmaceutical products. Since the unique secure code is embedded inside the product packaging using NFC tag, the unique secure code is generally invisible to the human eyes.

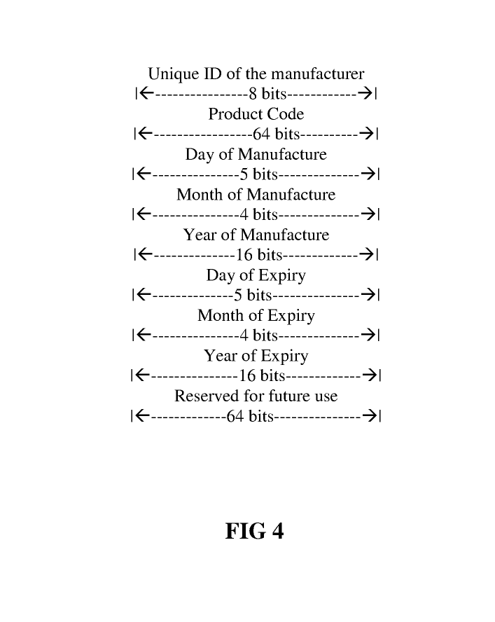

FIG. 4 illustrates the software generated binary code memory storage format according to one embodiment of the invention. Since NFC tag containing the unique secure code is embedded inside the internal area of the packaging using NFC tag, the NFC tag is generally invisible to the human eyes. The format in which may be stored inside the internal memory of the tag may comprise 8 bits for unique identification code of the manufacturer which may be stored in the authentication server (108, FIG. 1), 64 bits for product ID (each product manufactured using NFC tag technology may be provided with a product code), 5 bits for day of manufacture, 4 bits for month of manufacture, 16 bits for year of manufacture, 5 bits for day of expiry, 4 bits for month of expiry, 16 bits for year of expiry and 64 bits may be reserved for future e.g. in case the system uses digital signatures instead of using the internet or cloud computing environment. As an example, the generated binary code may be in the following format 00000100 00000000000000000 00000000 0000 00000000 0000000000000000 00001111 1011110000000111 11011011 10111100 111110 11100, the entire code is encrypted using public key of the manufacturer.

By using the embodiments of the invention, the pharmaceutical product manufacturers can save huge sum by participating in such a system of authentication. Every year drug manufacturers are losing significant sum due to the problem of counterfeit pharmaceutical products. The amount which they would need to spend on for participating in such a system which still would be significantly less than the losses they incur due to counterfeit pharmaceutical product. The present invention addresses the problem of counterfeit pharmaceutical products and may also be applied to any kind of consumer product authentication.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

We claim:

1. A counterfeit pharmaceutical product identification system for determining authenticity of pharmaceutical products, the system comprising:
a. at least pharmaceutical product (102) having at least one tag containing an encrypted unique secure code wherein the tag is embedded inside the packaging of the pharmaceutical product (102) making the unique secure code invisible to human eyes;
b. an authentication server (108) storing a database of pharmaceutical products (102) and the unique secure codes associated with each of the pharmaceutical products (102);
c. at least one mobile device (104) configured to read unique secure code embedded inside the packaging of the pharmaceutical product (102), by bringing the mobile device (104) in close proximity to the packaging wherein a short range communication system is used to establish connection between the mobile device (104) and the pharmaceutical product (102),
wherein the mobile device (104) authenticates the pharmaceutical product (102) by communicating with the authentication server (108) and comparing the unique secure code attached to the pharmaceutical product (102) with the secure code saved in the database.

2. The counterfeit pharmaceutical product identification system as claimed in claim 1 wherein in case the pharmaceutical product (102) is identified by the mobile device (104) as authentic, a success message, along with product details including date of manufacture and date of expiry, is displayed on the display screen of the mobile device (104) whereby identifying the genuine pharmaceutical product (102) instantly.

3. The counterfeit pharmaceutical product identification system as claimed in claim 1 wherein in case the pharmaceutical product (102) is not identified by the mobile device (104), a failure message is displayed on the display screen of the mobile device (104) whereby identifying the counterfeit pharmaceutical product (102) instantly.

4. The counterfeit pharmaceutical product identification system as claimed in claim 1 wherein the unique secure code further comprises at least one of:
a. manufacturer identification code of the pharmaceutical product (102);
b. product identification code of the pharmaceutical product (102);
c. manufacturing date of the pharmaceutical product (102);
d. manufacturing month of the pharmaceutical product (102);
e. manufacturing year of the pharmaceutical product (102);
f. expiry date of the pharmaceutical product (102);
g. expiry month of the pharmaceutical product (102); or
h. expiry year of the pharmaceutical product (102).

5. The counterfeit pharmaceutical product identification system as claimed in claim 1 wherein the result is transmitted in the form of an SMS (Short Messaging Service) or instant messaging by the mobile device (104).

6. The counterfeit pharmaceutical product identification system as claimed in claim 1 wherein the short range communication mode is any one of Near Field Communication (NFC) or Bluetooth® technology.

7. A counterfeit pharmaceutical product identification system for determining authenticity of pharmaceutical products using digital signatures, the system comprising:
a. at least one pharmaceutical product (102) having at least one tag containing an encrypted unique secure code wherein the secure code is having digital signature information of the manufacturer of pharmaceutical product (102) wherein the tag is embedded inside the packaging of the pharmaceutical product (102) making the unique secure code invisible to human eyes;
b. a mobile device (104) configured to read unique secure code embedded inside the packaging of the pharmaceutical product (102), by bringing the mobile device (104) in close proximity to the packaging wherein a short range communication system is used to establish connection between the mobile device (104) and the pharmaceutical product (102),
wherein the mobile device (104) authenticates the pharmaceutical product (102) by comparing the unique secure code attached to the pharmaceutical product (102) with the digital signatures information stored in the mobile device (104).

8. The counterfeit pharmaceutical product identification system as claimed in claim 7 wherein the unique secure code further comprises at least one of:
a. manufacturer identification code of the pharmaceutical product (102);
b. product identification code of the pharmaceutical product (102);
c. manufacturing date of the pharmaceutical product (102);
d. manufacturing month of the pharmaceutical product (102);
e. manufacturing year of the pharmaceutical product (102);
f. expiry date of the pharmaceutical product (102);
g. expiry month of the pharmaceutical product (102); or
h. expiry year of the pharmaceutical product (102).

9. The counterfeit pharmaceutical product identification system as claimed in claim 7 wherein in case the pharmaceutical product (102) is identified by the mobile device (104) as authentic, a success message, along with product details including date of manufacture and date of expiry, is displayed on the display screen of the mobile device (104) whereby identifying the genuine pharmaceutical products instantly.

10. The counterfeit pharmaceutical product identification system as claimed in claim 7 wherein in case the pharmaceutical product (102) is not identified by the mobile device (104), a failure message is displayed on the display screen of the mobile device (104) whereby identifying the counterfeit pharmaceutical product instantly.

11. The counterfeit pharmaceutical product identification system as claimed in claim 7 wherein the short range communication mode is any one of Near Field Communication (NFC) or Bluetooth® technology.

12. A method for determining authenticity of pharmaceutical products, the method comprising the steps of:
a. embedding the packaging of the pharmaceutical products with tags containing an encrypted unique secure code associated with corresponding pharmaceutical product;
b. storing the list of pharmaceutical products and their unique secure code in an authentication server;
c. activating an authentication application on the mobile device of the user;
d. bringing mobile device in close proximity to the packaging containing pharmaceutical product;
e. authenticating the pharmaceutical product by reading the embedded unique secure code inside the packaging and verifying with the unique secure code stored in the authentication server;
f. transmitting the result to the user.

13. The method as claimed in claim 12 wherein the method of embedding the packaging of the pharmaceutical products with tags containing an encrypted unique secure code further comprises the steps of:
a. generating a unique identification number for each of the pharmaceutical products;
b. storing the list of pharmaceutical products with corresponding unique secure code in a authentication server;
c. encrypting the unique secure code; and
d. embedding inside the packaging, the tags with unique secure code.

14. The method as claimed in claim 12 wherein the unique secure code further comprises at least one of:
a. manufacturer identification code of the pharmaceutical product;
b. product identification code of the pharmaceutical product;
c. manufacturing date of the pharmaceutical product;
d. manufacturing month of the pharmaceutical product;
e. manufacturing year of the pharmaceutical product;
f. expiry date of the pharmaceutical product;
g. expiry month of the pharmaceutical product;
h. expiry year of the pharmaceutical product; or
i. digital signature information of the pharmaceutical product manufacturer.

15. The method as claimed in claim 12 wherein in case the pharmaceutical product is identified by the mobile device as authentic, a success message, along with product details including date of manufacture and date of expiry, is communicated to the user whereby identifying the genuine pharmaceutical product instantly.

16. The method as claimed in claim 12 wherein in case the pharmaceutical product is not identified by the mobile device, a failure message is communicated to the user whereby identifying the counterfeit pharmaceutical product instantly.

17. The method as claimed in claim 12 wherein the result is transmitted in the form of an SMS (Short Messaging Service) or instant messaging by the mobile device for verification.
